(19) United States
(12) Patent Application Publication
(10) Pub. No.: US 2004/0197557 A1
(43) Pub. Date: Oct. 7, 2004

(54) Process for manufacturing hollow fibers

(76) Inventors: Ray R. Eshraghi, Cary, NC (US); Martin E. Ketterer, Apex, NC (US); Seth B. Carruthers, Garner, NC (US); Erik K. Yarbrough, Morrisville, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 10/811,347

(22) Filed: Mar. 26, 2004

Related U.S. Application Data
(60) Provisional application No. 60/457,903, filed on Mar. 27, 2003.

(51) Int. Cl. D01D 5/24; B32B 3/00

(52) U.S. Cl. 428/375; 264/166; 264/209.1; 264/171.26; 264/171.27; 264/41

(57) ABSTRACT

The present invention relates to processes for fabricating polymeric hollow fibers. Specifically, a removable solid core fiber is provided for coating one or more layers of a polymeric membrane-forming material thereon. After treating the polymeric membrane-forming material layer to form a solidified polymeric membrane having a permanent tubular shape, the solid core fiber is selectively removed, leaving an elongated lumen inside the solidified polymeric membrane, which forms a high quality polymeric hollow fiber that is substantially free of deformation defects. The solid core fiber can be made of a removable substrate material, such as water-soluble polymers polyvinyl pyrrolidone (PVP), polyvinyl alcohol (PVA), or polyethylene glycol (PEG), which are subsequently and selectively removable by water. Alternatively, the solid core fiber can be coated with a removable substrate material, which imparts removability to such solid core fiber.

### CROSS-REFERENCE TO RELATED APPLICATIONS

This claims priority to U.S. Provisional Patent Application No. 60/457,903, filed Mar. 27, 2003 in the names of Ray R. Eshraghi et al. for “PROCESS FOR MANUFACTURING HOLLOW FIBERS.”

### GOVERNMENT INTEREST

The U.S. government may own rights in the present invention, pursuant to Grant No. 70NANB1H3039 awarded by the Advanced Technology Program (ATP) of National Institute of Standard and Technology (NIST).

### BACKGROUND OF THE INVENTION

1. Field of the Invention

This invention in general relates to methods and systems for producing polymeric hollow fibers having tubular membrane walls and elongated lumens therein.

2. Description of the Related Art

Polymeric hollow fibers having elongated central lumens are useful in many industrial processes, which include, but are not limited to, membrane-based gas or liquid separation, biomedical cell culturing, and electrochemical power generation.

For example, in membrane-based liquid separation process, a liquid mixture is passed through either the bore sides or the shell sides of multiple microporous hollow fibers. Some components of such liquid mixture diffuse through the microporous walls of such hollow fibers into the shell or bore sides of the hollow fibers, forming a permeate, while other components are selectively rejected by such microporous walls and therefore form a retentate. The porosity of such hollow fibers determines the specific compositions of the permeate and the retentate.

In membrane-based gas separation process, a feed gas that comprises a mixture of two or more gaseous components is provided at either the bore sides or the shell sides of the hollow fibers under sufficiently high pressure, so that a gaseous component having a relatively higher permeation rate (i.e., the “fast” gas) diffuses through the fiber walls into the other sides of the hollow fibers, while another gaseous component having a relatively lower permeation rate (i.e., the “slow” gas) remains. The “fast” gas is subsequently channeled away from the hollow fibers as a permeate gas, and the remaining “slow” gas is subsequently collected as a retentate gas.

Hollow-fiber cell culture technology utilizes hollow fibers having adjustable molecular weight cut off (MWCO) to create a semi-permeable barrier between the cell-growth area and the culturing medium. By adjusting the MWCO of such hollow fibers, the chemical environment surrounding the cell culture can be optimized to encourage cell growth and increase yield of associated biological products.

Microporous hollow fibers impregnated with electrolytic medium, or hollow fibers made of ion-exchange polymers can also be used for forming tubular membrane-electrode-assemblies (MEA) in electrochemical power generation systems, or for drying or humidifying electrochemical devices.

Conventional methods for producing polymeric hollow fibers, as disclosed in U.S. Pat. No. 5,209,883, RE32,277, and 3,940,469, rely on use of a spinnerette, which comprises an annular extrusion orifice and a central bore-forming tube, for extruding a polymeric material into hollow fibers. Specifically, a polymeric dope or extrudate, which is formed of either a molten polymeric material (as in melt extrusion) or a polymeric material dissolved in a solvent (as in solution extrusion), is pumped through the annular extrusion orifice of such spinnerette, and a bore-forming liquid or gas is concurrently forced through the central bore-forming tube of such spinnerette, to extrude a polymeric precursor article having a relatively “soft” tubular wall formed of the molten polymer or the polymeric solution. Subsequently curing and/or drying of such tubular wall forms a polymeric hollow fiber.

However, the polymeric hollow fibers formed by such conventional methods usually contain high deformation defects formed during the curing and/or drying steps, and are vulnerable to breakage in subsequent winding and packaging steps. The deformation defects and breakage of the polymeric hollow fibers adversely affect the performance of such fibers.

It is therefore an object of the present invention to provide a method and apparatus for producing polymeric hollow fibers that are substantially free of deformation defects and breakage.

It is another object of the present invention to provide an automated and scale-up process for commercial production of high quality polymeric hollow fibers at reduced costs.

Other objects and advantages of the present invention will be more fully apparent from the ensuing disclosure and appended claims.

### SUMMARY OF THE INVENTION

The present invention in one aspect relates to a method for forming polymeric hollow fibers, each of which comprises a tubular membrane wall enclosing an elongated lumen therein. Such method specifically comprises the steps of:

(a) providing a solid core fiber;

(b) coating at least one layer of a removable substrate material over such solid core fiber;

(c) coating at least one layer of a polymeric membrane-forming material over the removable substrate material layer;

(d) treating such polymeric membrane-forming material layer to form a solidified polymeric membrane; and

(e) removing the removable substrate material layer and the solid core fiber from within the solidified polymeric membrane.

In the above-described method, the solid core fiber provides a solid support to the polymeric membrane-forming material layer(s), therefore preventing deformation of such membrane-forming material layer before it solidifies and attains a permanent shape. The removable substrate material coating between the solid core fiber and the polymeric membrane-forming material layer is removed after formation of a solidified polymeric membrane, leaving a hollow space around the solid core fiber and completely disengaging such solid core fiber from the solidified polymeric membrane. Correspondingly, the disengaged solid core fiber can be pulled out of the polymeric membrane (or otherwise removed therefrom) to form an elongated lumen inside such polymeric membrane.

In an alternative embodiment of the present invention, the solid core fiber itself is formed of a solid-phase removable substrate material, and at least one layer of a polymeric membrane-forming material is coated directly onto such solid core fiber. After the polymeric membrane-forming material layer is treated for a sufficient period of time to form a solidified polymeric membrane of a tubular shape, the solid core fiber is removed from within the polymeric membrane, so as to form a well-defined elongated lumen inside the tubular polymeric membrane.

In a further alternative embodiment of the present invention, a swellable polymeric membrane-forming material is employed, which is characterized by its capability to undergo volumetric expansion upon contacting a swelling agent. One or more layers of such swellable polymeric membrane-forming material are coated directly onto a solid core fiber, and treated for a sufficient period of time, to form a polymeric membrane having a permanent tubular shape. Such polymeric membrane is then contacted with a swelling agent (i.e., any liquid or gas that interacts with the polymeric membrane and causes it to expand), expands, and becomes disengaged from the solid core fiber. Subsequent removal of the solid core fiber from inside the disengaged polymeric membrane forms a polymeric hollow fiber with a well-defined elongated lumen therein.

The term “solid” or “solid-phase” as used herein refers to the state of a material, as being a non-liquid or a non-gaseous material, or the firmness of the material in substance or construction that is sufficient to provide the necessary structural support.

The term “fibrous” or “fiber” as used herein refers to an elongated structure having a cross-sectional outer diameter in a range of from about 10 micron to about 10 millimeter, preferably from about 10 micron to about 5 millimeter, and more preferably from about 10 micron to about 1 millimeter.

Another aspect of the present invention relates to a method for forming an ion-exchange polymeric hollow fiber, such method comprising the steps of:

(a) providing a solid core fiber that is subsequently and selectively removable;

(b) coating at least one layer of an ion-exchange polymeric membrane-forming material over the solid core fiber;

(c) treating such ion-exchange polymeric membrane-forming material layer to form a solidified ion-exchange polymeric membrane; and

(d) removing the solid core fiber from within the solidified ion-exchange polymeric membrane, so as to form an ion-exchange polymeric hollow fiber having an ion-exchange tubular membrane wall enclosing an elongated lumen therein.

A further aspect of the present invention relates to a method for forming a polymeric hollow fiber having a porous tubular membrane wall, such method comprising the steps of:

(a) providing a solid core fiber that is subsequently and selectively removable;

(b) coating at least one layer of a mixture over the solid core fiber, wherein such mixture comprises a polymeric membrane-forming material and a removable pore-forming material;

(c) treating such mixture layer to form a solidified membrane structure; and

(d) removing the solid core fiber from the solidified membrane structure; and

(e) removing the pore-forming material from the solidified membrane structure,

(f) wherein steps (d) and (e) can be carried out either simultaneously, or sequentially in any order.

The term “porous” as used herein refers to pore sizes ranging from 1 Angstrom to about 10 microns. Membranes having such pore sizes are suitable for applications in microfiltration, ultrafiltration, reverse osmosis, or gas separation processes.

The present invention in a still further aspect relates to a co-extrusion method, which combines both melt extrusion and solution extrusion for forming a polymeric hollow fiber.

Such co-extrusion method specifically comprises the steps of:

(a) providing a molten removable substrate material;

(b) providing a viscous solution of a polymeric membrane-forming material;

(c) co-extruding the molten removable substrate material and the viscous solution of the polymeric membrane-forming material, to form a fibrous structure comprising a fibrous core enclosed by a membrane wall, wherein such fibrous core is formed by the molten removable substrate material, and wherein such membrane wall is formed by the viscous solution of the polymeric membrane-forming material;

(d) cooling the fibrous structure to solidify the fibrous core formed of the molten removable substrate material;

(e) subsequently, treating the fibrous structure to solidify the membrane wall formed of the viscous solution of the polymeric membrane-forming material; and

(f) removing the fibrous core from the solidified membrane wall.

In a preferred embodiment of the present invention, such co-extrusion method uses an ion-exchange polymer as the polymeric membrane-forming material.

In another preferred embodiment of the present invention, such co-extrusion method forms a polymeric hollow fiber having a porous tubular membrane wall, by:

(a) providing a molten removable substrate material;

(b) providing a viscous solution comprising a mixture of a polymeric membrane-forming material and a removable pore-forming material;

(c) co-extruding the molten removable substrate material and the viscous solution, to form a fibrous structure comprising a fibrous core enclosed by a membrane wall, wherein such fibrous core is formed by the molten removable substrate material, and wherein such membrane wall is formed by the viscous solution of the mixture;

(d) cooling the fibrous structure to solidify the fibrous core;

(e) treating the fibrous structure with a coagulating agent, to solidify the membrane wall and concurrently remove the pore-forming material from such membrane wall, forming a solidified polymeric membrane having a porous structure; and

(f) removing the fibrous core from such solidified, porous polymeric membrane.

Other aspects, features and advantages of the invention will be more fully apparent from the ensuing disclosure and appended claims.

### BRIEF DESCRIPTION OF THE DRAWINGS

FIG. 1 is a cross-sectional view of an extrusion die for coating a single layer of an extrudate material onto a core fiber.

FIG. 2 is a cross-sectional view of an extrusion die for simultaneously coating a first layer of a first extrudate material and a second layer of a second extrudate material onto a core fiber.

FIGS. 3A and 3B shows a system for processing a polymeric material and coating such material onto a core fiber.

FIG. 4 shows a process for producing a Nafion® hollow fiber, according to one embodiment of the present invention.

FIG. 5 shows a process for producing an ion-exchange polymeric hollow fiber, according to one embodiment of the present invention.

FIG. 6 shows a cross-sectional view of a removal interface inside a solid core fiber formed of a removable substrate material, according to one embodiment of the present invention.

FIG. 7 shows a process for forming a removal interface inside a solid core fiber, according to one embodiment of the present invention.

FIG. 8 shows a process for producing a polymeric hollow fiber having a porous tubular membrane, according to one embodiment of the present invention.

### DETAILED DESCRIPTION OF THE INVENTION, AND PREFERRED EMBODIMENTS THEREOF

The present invention in one aspect employs a removable solid core or substrate for forming polymeric hollow fibers.

One or more layers of a polymeric membrane-forming material are coated over such removable solid core or substrate, and are cured, dried, or otherwise treated thereon, to form a solidified tubular polymeric membrane around the solid core or substrate. During the process of solidification, the solid core or substrate provides mechanical support to the polymeric membrane-forming material coatings, and effectively prevents/reduces deformation defects in the solidified polymeric membrane. Subsequent removal of such solid core or substrate from within the solidified polymeric membrane forms a polymeric hollow fiber, which has a deformation-free tubular polymeric membrane and a well defined elongated lumen therein.

The Solid Core Fiber

The solid core fiber as mentioned hereinabove can be made of any solid material(s), including but not limited to: metals, metal alloys, glass, ceramics, carbons, polymers, etc. Such solid core fiber is characterized by a cross-sectional outer diameter preferably in a range of from about 10 micron to about 10 millimeter.

The Removable Substrate Material

In a preferred embodiment of the present invention, at least one removable substrate material is coated onto the solid core fiber, for imparting selective removability to the solid core fiber.

The removable substrate material may be any suitable material that is subsequently and selectively removable. For example, such removable substrate material can be selectively sublimable, meltable, or soluble under specific conditions, which is subsequently and selectively removed via sublimation, melting, or dissolution under such conditions. Preferably, the removable substrate material is a soluble material, and more preferably a water-soluble polymeric material that is selectively removable by water. Suitable water-soluble polymeric materials include, but are not limited to, polyvinyl pyrrolidones (PVP), polyvinyl alcohols (PVA), polyethylene glycols (PEG), etc., among which polyvinyl pyrrolidones (PVP), polyvinyl alcohols (PVA), and polyethylene glycols (PEG) are particularly preferred in the present invention.

Coating of the removable substrate material onto the solid core fiber can be carried out by various methods, including melt extrusion, solution extrusion, spray coating, brush coating, dip-coating, and vapor deposition. Melt extrusion and solution extrusion are preferred in the present invention, by providing a viscous extrudate, which comprises either a molten removable substrate material, or a viscous solution of the removable substrate material dissolved in a suitable solvent, and concurrently passing such viscous extrudate and the solid core fiber through an extrusion die, to form a coated fiber with a coating of the removable substrate material. The coated fiber is then cooled and/or dried for a sufficient period of time to solidify the removable substrate material coating.

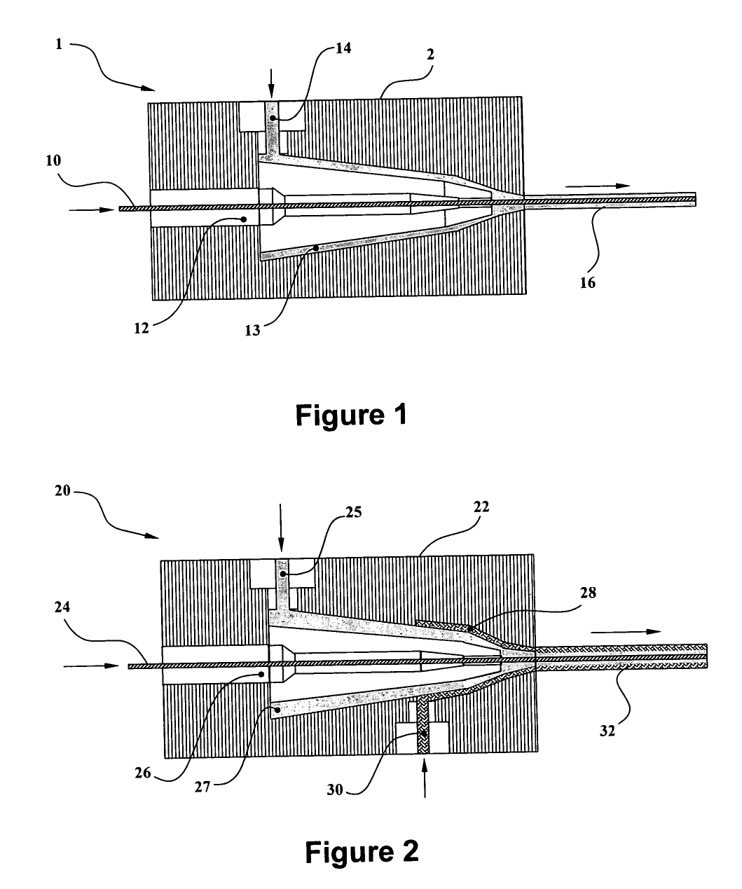

FIG. 1 shows an extrusion die 1 that can be used to coat the removable substrate material onto a solid core fiber. Specifically, extrusion die 1 comprises a heated housing 2 having an inner manifold 12 and an outer manifold 13, which are sealed from each other in a leak-tight manner. A solid core fiber 10 is fed into such extrusion die 1 through the inner manifold 12, while a viscous extrudate or dope 14 of the removable substrate material (molten or dissolved in a suitable solvent) is fed into such extrusion die 1 through the outer manifold 13. Accordingly, a thin layer of the viscous extrudate 14 is extruded around the solid core fiber 10, forming a coated fiber 16. Subsequent cooling and/or drying of such coated fiber solidifies the viscous extrudate coating and forms a solidified fiber structure, over which a polymeric membrane-forming material can be applied.

In an alternative embodiment of the present invention, the solid core fiber is itself removable in character (i.e., it comprises the removable substrate material as described hereinabove and is therefore selectively removable). In such embodiment, no additional coating of removable substrate material is required, and the polymeric membrane-forming material is directly coated over such removable solid core fiber.

The Polymeric Membrane-forming Material

The polymeric membrane-forming material is employed in the present invention to form the tubular polymeric membrane of a polymeric hollow fiber, by: (1) coating such polymeric membrane-forming material around a removable solid core or substrate, which may comprise either a coated fiber having a removable substrate material coating, or a solid core fiber made of a removable substrate material, (2) treating the polymeric membrane-forming material coating for a sufficient period of time to form a solidified polymeric membrane, and (3) subsequently removing the removable solid core or substrate from within the solidified polymeric membrane.

Such polymeric membrane-forming material can be any polymeric material that is suitable for forming membrane structures, which includes, but is not limited to, polysulfone, polypropylene, polyacrylonitrile, polytetrafluoroethylene (PTFE), polyethylene, polyvinylidene fluoride (PVDF), polyamide, polyethyl methacralyte, regenerated cellulose acetate, and cellulose triacetate, etc. The specific choice of such polymeric membrane-forming material depends on the specific uses contemplated for the hollow fiber end products.

Preferably, such polymeric membrane-forming material comprises a solid ion-exchange polymer (i.e., either a cationic exchange polymer or an anionic exchange polymer), such as perfluorocarbon-sulfonic-acid-based polymers, polysulfone-based polymers, perfluorocarboxylic-acid-based polymers, styrene-vinyl-benzene-sulfonic-acid-based polymers, styrene-butadiene-based polymers, etc. More preferably, such polymeric membrane-forming material comprises a perfluorosulfonate ionomer, such as the Nafion® membrane material manufactured by DuPont at Fayetteville, N.C.; Flemion® membrane material manufactured by Asahi Glass Company at Tokyo, Japan; and Aciplex® membrane material manufactured by Asahi Chemical Company at Osaka, Japan.

Such polymeric membrane-forming material may also be mixed with a pore-forming agent that can be subsequently leached or extracted out of the polymeric matrix, to form a porous membrane structure, as described in U.S. Pat. Nos. 5,916,514; 5,928,808; 5,989,300; 6,004,691; 6,338,913; 6,399,232; 6,403,248; 6,403,517; 6,444,339; 6,495,281; all to Ray R. Eshraghi, the contents of which are incorporated by referenced in their entirety for all purposes.

Coating of the polymeric membrane-forming material onto the removable solid core or substrate can be carried out by methods and apparatuses similar to those described hereinabove for coating of the removable substrate material onto the solid core fiber. Specifically, when the polymeric membrane-forming material comprises a perfluorosulfonate ionomer, such as the Nafion® membrane material, solution extrusion method is preferably employed for coating such polymeric membrane-forming material.

The extrusion die 1 of FIG. 1 can also be used for coating of the polymeric membrane-forming material over a removable solid core or substrate. A coated fiber having a removable substrate material coating, or a solid core fiber made of a removable substrate material, is fed into the extrusion die 1 through the inner manifold 12, while a viscous extrudate or dope of the polymeric membrane-forming material (molten or dissolved in a suitable solvent) is fed into such extrusion die 1 through the outer manifold 13. Accordingly, a thin layer of the polymeric membrane-forming material is extruded around the coated fiber or the solid core fiber.

Further, two or more layers of the same polymeric membrane-forming material, or different membrane-forming materials, can be simultaneously extruded onto a removable solid core or substrate, using a multi-annular extrusion die. FIG. 2 shows a double-annular extrusion die 20 comprising a housing 22, with an inner manifold 26, an intermediate manifold 27, and an outer manifold 28. The inner, intermediate, and outer manifolds are concentric to one another, and are sealed from one another in a leak-tight manner. A removable core or substrate 24 (which can be either a coated fiber containing a solid core fiber and a removable substrate material coating, or a solid core fiber formed of the removable substrate material) is fed into such extrusion die 20 through the inner manifold 26; a first viscous extrudate or dope 25 of a polymeric membrane-forming material (molten or dissolved in a suitable solvent) is fed into such extrusion die 20 through the intermediate manifold 27; and a second viscous extrudate or dope 30 of a polymeric membrane-forming material (molten or dissolved in a suitable solvent) is fed into such extrusion die 20 through the outer manifold 28. Accordingly, two layers of polymeric membrane-forming material are extruded around the removable core or substrate 24, forming a multi-layer coated fiber 32, which can be subsequently treated so as to solidify such layers of polymeric membrane-forming material.

The polymeric membrane-forming material contained by the first viscous extrudate 25 may be different from that contained by the second viscous extrude 30, to form polymeric hollow fibers characterized by a double-membrane structure. Alternatively, if solution extrusion method is used, the first and the second viscous extrudate 25 and 30 may comprise solutions of the same polymeric membrane-forming material at different concentrations. For example, the first viscous extrudate 25 can comprise a 20% Nafion® solution by weight, and the second viscous extrudate 30 can comprise a 5% Nafion® solution by weight. Such second viscous extrudate 30, being less viscous than the first extrudate 25, functions to fill the pinholes (if any) in the polymeric coating extruded from the first, more viscous extrudate 25 to provide a smooth coating surface. The specific compositions of the first and second (or additional) viscous extrudates depend on the specific uses contemplated for the hollow fiber subsequently formed, and can be readily determined by a person ordinarily skilled in the art.

The extruded polymeric membrane-forming layers are subsequently treated, according to techniques well known in the art, to form a solidified polymeric membrane having a permanent tubular shape.

Additionally, one or more reinforcing fibers can be incorporated into such polymeric membrane to form a fiber-reinforced tubular polymeric membrane structure. Preferably, such reinforcing fibers extend continuously along the longitudinal axis of the fibrous core or substrate and therefore provide axial reinforcement to the hollow fibrous membrane. Fiberglass yarn having an average diameter of about 0.1-500 μm is particularly suitable for practice of the present invention, while other fibrous materials, including but not limited to carbon fibers, metal fibers, resin fibers, and composite fibers, can also be employed for reinforcing the hollow fibrous membrane. The reinforcing fiber can either be co-extruded with one of the polymeric membrane-forming layers, or be encapsulated between two polymeric membrane-forming layers, to form an integral part of the hollow fibrous membrane.

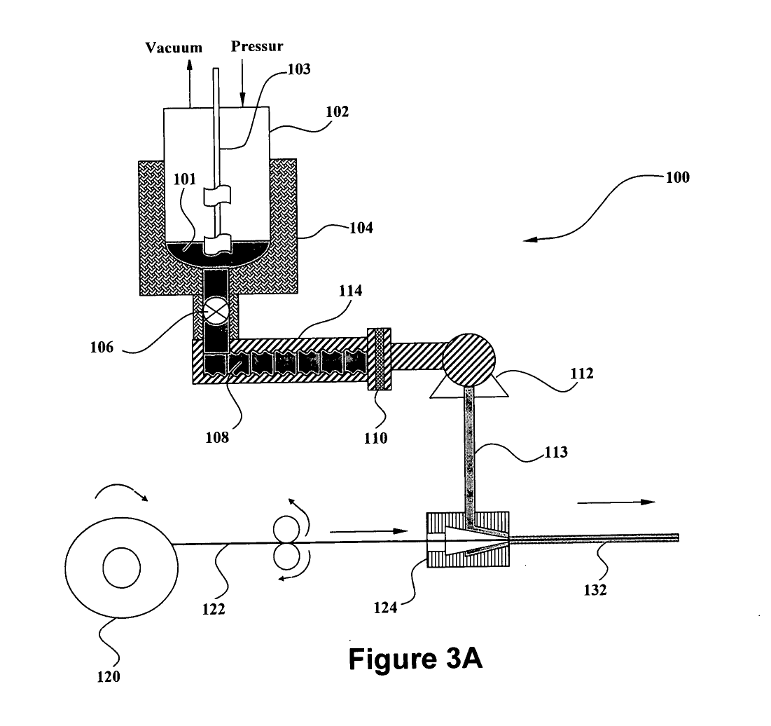

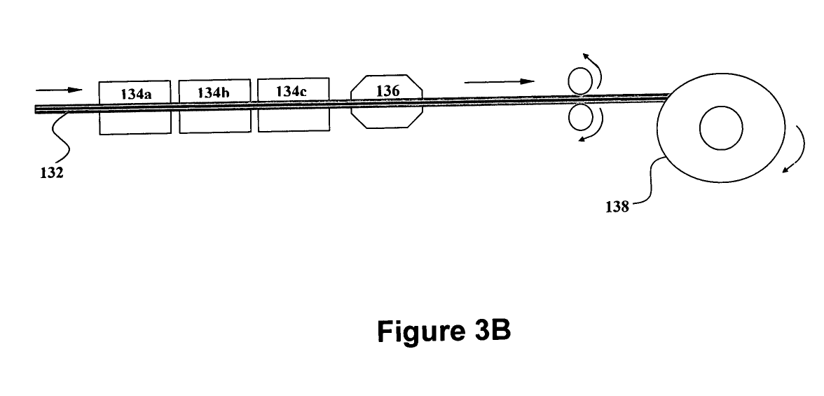

FIGS. 3A and 3B depict an exemplary system 100 for forming a solidified polymeric membrane by solution extrusion. FIG. 3A shows a mixing vessel 102 having a mixing stirrer 103, for mixing a polymeric membrane-forming material with a suitable solvent, to form a viscous polymeric solution 101. The mixing vessel 102 is preferably fit into a heating mantle 104, for heating the polymeric solution 101 to an elevated temperature. Viscosity of such polymeric solution 101 is adjusted according to various factors, such as concentration of the polymeric membrane-forming material in such solution, the types of solvent(s) used, and temperature of such solution, etc. The viscous polymeric solution 101 is pumped through a valve 106, an auger screw 108, and a filter 110 by a pump 112, which are preferably heated by heating devices 114 (e.g., heating tapes or resistance heaters) to maintain such polymeric solution at the elevated temperature. The pump 112 is connected to a fluid conduit 113, for feeding the viscous polymeric solution 101 therethrough into an extrusion die 124; simultaneously, a string or a tow of removable core fiber 122 from a spool 120 is passed through the extrusion die 124. A thin layer of the viscous polymeric solution 101 is therefore applied onto the removable core fiber 122, forming a coated fiber 132. The coated fiber 132 is subsequently passed through incremental heating zones 134a, 134b, and 134, as shown in FIG. 3B, in which the solvent evaporates from the viscous polymeric coating of the coated fiber 132, and such viscous polymeric coating is accordingly cured and solidified to attain a permanent tubular shape that is resistant to deformation or breakage. The solidified fiber 132 is then cooled in cooling zone 136, wound onto a spool 138, and packed for subsequent processing or treatment.

Note that the broad scope of the present invention is not limited by the structures and compositions explicitly described hereinabove. Such structures and compositions are provided for exemplary purposes only and should not be construed as limitations of the present invention. A person ordinarily skilled in the art can further modify the structures and compositions of the removable core fiber 122 and the viscous polymeric solution 101, consistent with the disclosure herein, to form specific fibrous structures suitable for specific industrial applications, which are within the scope of the present invention.

U.S. Pat. No. 6,455,156 issued to Tanaka et al. on Sep. 24, 2002 discloses a method for forming a hollow fiber, by melt kneading a water soluble PVA polymer with a thermoplastic polymer and then co-spinning such molten materials into a conjugate fiber having a sea-island structure, in which the island components are formed by the molten water-soluble PVA polymer, and the sea components are formed by the molten thermoplastic polymer. The water-soluble PVA island components are subsequently dissolved in water, to form a thermoplastic hollow fiber with multiple hollow portions.

Such Tanaka patent, however, does not contemplate in any manner the need for providing a solid core or substrate to support the molten thermoplastic polymer against deformation before it completely solidifies and attains a permanent shape. In the melt kneading and co-spinning method specifically disclosed by the Tanaka patent, the molten PVA island components and the molten thermoplastic sea components of the conjugate fiber simultaneously solidify upon cooling, and there is no teaching or suggestions about providing any solid support to the molten thermoplastic sea components during its solidification process.

The present invention therefore distinguishes over the Tanaka patent, by providing a solid core fiber for supporting the polymeric membrane-forming material coating before it solidifies and forms a polymeric membrane, which is neither disclosed nor contemplated by the Tanaka patent.

Moreover, the Tanaka patent relates to hollow fibers for textile applications, which are formed by melt extrusion process and comprise fibrous polymeric matrix (i.e., the thermoplastic sea components) enclosing multiple hollow portions of various regular or irregular shapes.

In contrast, the present invention relates to formation of hollow fibers for membrane-based applications such as gas or liquid separation, biomedical cell culturing, or electrochemical processes, in which the hollow fibers function as membrane separators and are characterized by fiber walls having a well defined membrane conformation and enclosing elongated lumens therein. Such membrane-type fiber walls are preferably formed in the present invention by solution extrusion techniques, in light of the fact that solution extrusion provides precise control over the conformation and surface morphology of the membrane walls, in comparison with melt extrusion.

Nothing in Tanaka discloses or implies formation of hollow fibers having such membrane-type fiber walls, nor does Tanaka suggest in any manner the usage of solution extrusion techniques. Therefore, the present invention further distinguishes over the Tanaka patent, by forming hollow fibers with tubular membrane walls based on solution extrusion methods.

Removal of the Solid Core or Substrate

Selective removal of the solid core or substrate from within the solidified polymeric membrane can be effectuated by various techniques, including, but not limited to, sublimation, melting, solution, chemical etching, etc., depending on the specific removable substrate material used for forming such solid core or substrate.

Preferably, a removal interface is provided to facilitate such selective removal of the solid core or substrate, by exposing at least a portion of the removable substrate material in such solid core or substrate to a removing agent (such as acid, alkali, organic solvent, water, etc.). More preferably, such removal interface is a cavity or a lumen disposed inside the removable substrate material, which has exterior openings to allow flow of a removing fluid therethrough for continuous removal of the removable substrate material.

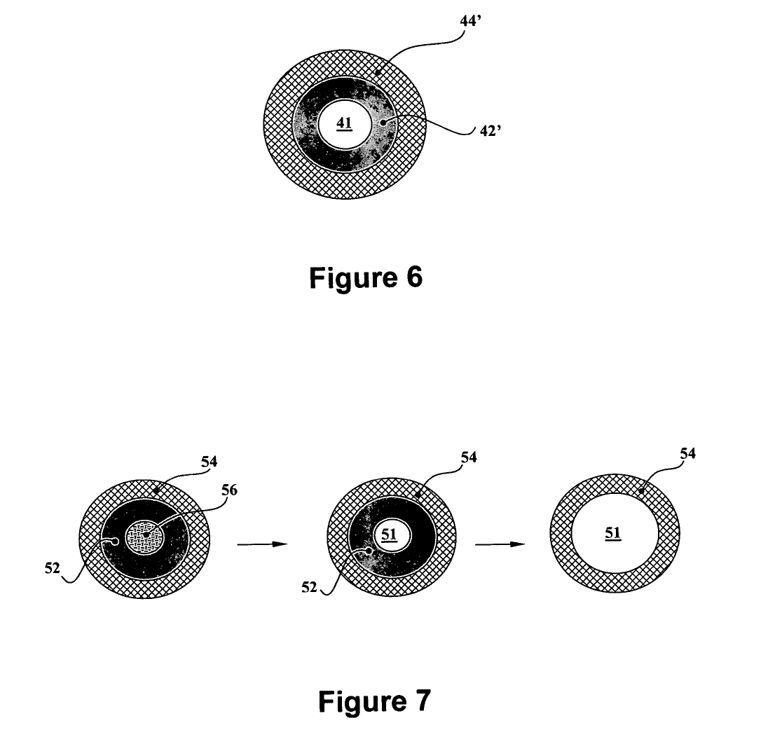

FIG. 6 shows the cross-sectional view of a coated fiber, having a removable core structure coated by a layer of a polymeric material 44′, wherein such core structure comprises an open cavity 41 inside a removable substrate material 42′. The open cavity 41 extends throughout the core structure and has exterior openings for flowing a removing fluid (e.g., acid, alkali, organic solvent, or water) therethrough to removal the substrate material 42′. The open cavity can either be in the middle of the removable substrate material 42′, as shown in FIG. 6, or near the edge of the removable substrate material 42′, or otherwise positioned inside the removable substrate material 42′, which, although not explicitly illustrated, can be readily determined by a person ordinarily skilled in the art and is therefore within the scope of the present invention.

The removal interface can be either provided ab initio, as shown in FIG. 6, or formed subsequently, by using two or more removable substrate materials of different removability. FIG. 7 shows the process of subsequently forming a removal interface, by using a removable core structure that comprises two removable substrate materials 56 and 52 of different removability. A first removable substrate material 56 (which can be either solid phase or non-solid-phase material) is coated by a second, solid-phase removable substrate material 52, and the first removable substrate material 56 is more readily removable than the second, solid-phase removable substrate material 52. A layer of a polymeric membrane-forming material 54 is coated over the second, solid-phase removable substrate material 52. After solidification of polymeric membrane-forming material layer 54, the first removable substrate material 56 is removed first, leaving an open cavity 51 inside the second, solid-phase removable substrate material 52. A removing fluid is then passed through the open cavity 51 to remove the second, solid-phase removable substrate material 52, and to form a hollow fiber comprising the tubular polymeric membrane 54 with an elongated lumen 51 therein.

Various combinations of removable substrate materials can be used for constructing such removable core structure a shown in FIG. 7. For example, the first removable substrate material 56 may comprise a polyvinyl alcohol of a relatively low molecular weight and a relatively high water solubility, while the second removable substrate material 52 may comprise a polyvinyl alcohol of a relatively high molecular weight and a relatively low water solubility. The first removable substrate material 56 is therefore more readily removable by water (i.e., the removing agent for water-soluble polymeric substrate materials) than the second removable substrate material 52. Further, the removable core structure may comprise more than two removable substrate materials of different removability, as long as a solid-phase removable substrate material is provided at the outermost layer, to give structural support for the polymeric membrane-forming material subsequently coated thereon.

Formation of Polymeric Hollow Fibers by Using a Swelling Agent

Certain polymeric membrane-forming materials are capable of “swelling” (i.e., expanding volumetrically) if contacted with a swelling agent, such as water or an organic solvent.

The present invention therefore in one aspect provides a method for forming polymeric hollow fibers using such swellable polymeric membrane-forming materials. The swellable polymeric membrane-forming material is directly coated onto a solid core fiber that is free of any removable substrate material, and after solidification of such swellable polymeric membrane-forming material, a swelling agent is contacted with the solidified polymeric membrane to effectuate volumetric expansion and disengagement of such polymeric membrane from the solid core fiber. The disengaged polymeric membrane can then be separated from the solid core fiber and further processed to remove the swelling agent, forming a polymeric hollow fiber.

The swelling agent can be any liquid or gas that interacts with a polymeric membrane-forming material and causes such material to undergo volumetric expansion. Such swelling agent is preferably a liquid solvent, such as water or an organic solvent. The swellable polymeric membrane-forming material is preferably an ion-exchange polymer selected from the group consisting of perflurocarbon-sulfonic-acid-based polymers and polysulfone-based polymers, more preferably a perfluorosulfonate ionomer, such as the Nafion® membrane material manufactured by DuPont at Fayetteville, N.C.

In a preferred embodiment of the present invention, the swellable polymeric membrane-forming material comprises Nafion® membrane material, and the swelling agent comprises water. One or more layers of a Nafion® solution are applied to a solid core fiber and are treated thereon, to form a solidified tubular Nafion® membrane structure. Such Nafion® membrane structure is then contacted with water, which causes it to expand and becomes disengaged from the solid core fiber. By pulling the solid core fiber out of such tubular Nafion® membrane and optionally removing excess water therefrom, a high quality Nafion® hollow fiber is formed, which has a tubular membrane wall that is substantially free of deformation defects.

Formation of an Ion-exchange Hollow Fiber

A particular preferred embodiment of the present invention relation relates to formation of an ion-exchange polymeric hollow fiber, by:

(a) providing a solid core fiber that is subsequently and selectively removable;

(b) coating at least one layer of an ion-exchange polymeric membrane-forming material over the solid core fiber;

(c) treating such ion-exchange polymeric membrane-forming material layer to form an ion-exchange polymeric membrane of a permanent shape; and

(d) removing the solid core fiber from the ion-exchange polymeric membrane, so as to form an ion-exchange hollow fiber as described hereinabove.

The ion-exchange polymeric membrane-forming material is preferably selected from the group consisting of: perflurocarbon-sulfonic-acid-based polymers, polysulfone-based polymers, perfluorocarboxylic-acid-based polymers, styrene-vinyl-benzene-sulfonic-acid-based polymers, and styrene-butadiene-based polymers. More preferably, such ion-exchange polymer is selected from the Nafion® membrane material manufactured by DuPont at Fayetteville, N.C.; the Flemion® membrane material manufactured by Asahi Glass Company at Tokyo, Japan; and the Aciplex® membrane material manufactured by Asahi Chemical Company at Osaka, Japan.

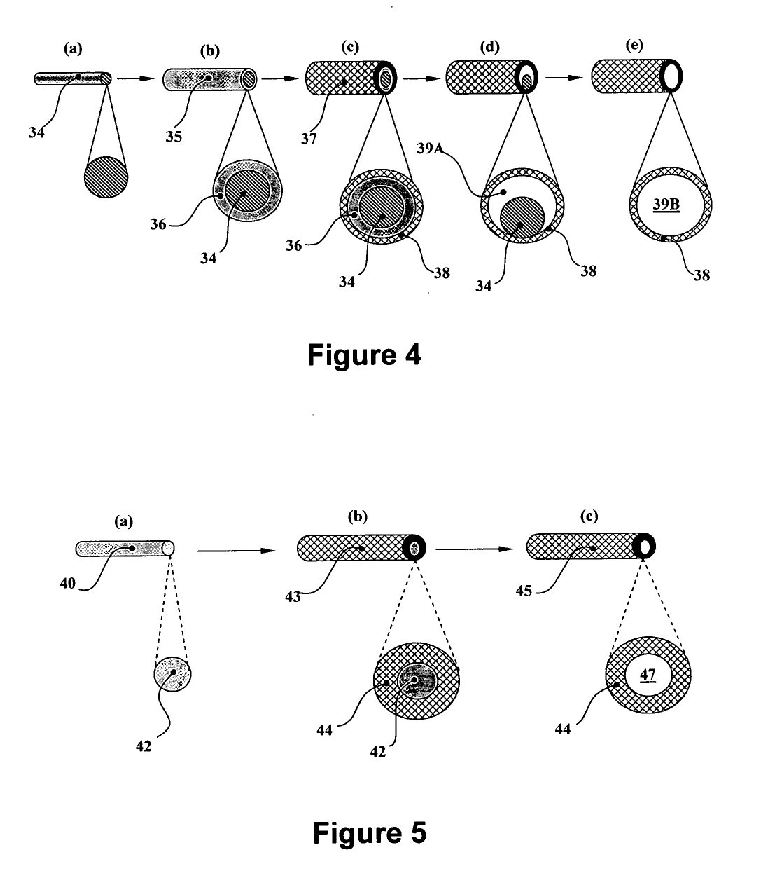

FIG. 4 shows a process for forming a Nafion®D polymeric hollow fiber, according to one embodiment of the present invention.

In step (a), a solid core fiber 34 is provided, onto which a layer of a removable substrate material 36 is coated to form a coated fiber 35, as shown in step (b). In step (c), a thin layer of a viscous Nafion® solution is extruded onto such coated fiber 35, by pulling the coated fiber 35 through an above-described extrusion die that is filled with a 2040 w/% Nafion® solution.

The Nafion® solution layer is then treated, by (1) contacting it with a coagulating solution, such as water, (2) drying it at a first elevated temperature in a range of from about 25° C. to about 100° C., preferably about 70° C., to remove the solvent from the Nafion® solution, (2) curing it at a second elevated temperature that is at least the glass transition temperature (Tg) of the Nafion® membrane material (>80° C.), preferably within a range of from about 110° C. to about 250° C., and most preferably in a range of from about 110° C. to about 150° C., and (3) cooling the cured Nafion® membrane material to form a solidified Nafion® membrane 38 over the removable substrate membrane layer 36. A person ordinarily skilled in the art can readily modify the drying and curing temperatures for a different ion-exchange polymeric membrane-forming material, according to the specific properties of such material, as well as the specific requirements for the polymeric membrane layer to be formed thereby.

In step (d), the removable substrate material layer 36 is selectively removed, forming hollow space 39A around the solid core fiber 34 and disengaging such solid core fiber 34 from the interior surface of the Nafion® membrane 38. The disengaged solid core fiber 34 can then be pulled out of the Nafion® membrane 38, or otherwise removed therefrom, to form a Nafion® hollow fiber comprising the Nafion® membrane 38 with an elongated lumen 39B therein.

FIG. 5 shows a process for forming an ion-exchange polymeric hollow fiber, according to an alternative embodiment of the present invention. In step (a), a solid core fiber 40 made of a removable substrate material 42 is provided, over which a layer of an ion-exchange polymeric membrane-forming material 44 is directly coated, as in step (b) to form a coated fiber 43. Such coated fiber 43 is then treated to solidify the ion-exchange polymeric membrane-forming material 44. In step (c), the solid core fiber made of the removable substrate material 42 is selectively removed from within the solidified ion-exchange polymeric membrane 44, therefore forming a hollow fiber 45 comprising the ion-exchange polymeric membrane 44 with an elongated lumen 47 therein.

Ion-exchange polymers such as Nafion demonstrate significant dimension changes depending on hydration or dehydration of such polymers. Specifically, the hydrophilicity of such ion exchange polymers causes excessive swelling of the polymeric structure upon hydration, and corresponding shrinking upon dehydration. Repeated swelling and shrinking eventually result in deformation and deterioration of the polymer structure.

Therefore, in a preferred embodiment of the present invention, one or more reinforcing fibers can be incorporated into the ion-exchange polymeric membrane to eliminate or reduce the dimensional changes caused by swelling and shrinking of the ion-exchange polymer. Preferably, such reinforcing fibers extend continuously along the longitudinal axis of the fibrous core or substrate and therefore limit longitudinal or axial swelling/shrinking of the polymeric membrane structure. Fiberglass yarn having an average diameter of about 0.1-500 μm is particularly suitable for practice of the present invention, while other fibrous materials, including but not limited to carbon fibers, metal fibers, resin fibers, and composite fibers, can also be employed for reinforcing the hollow fibrous ion-exchange polymeric membrane. The reinforcing fiber can either be co-extruded with one of the ion-exchange polymeric membrane-forming layers, or be encapsulated between two ion-exchange polymeric membrane-forming layers, to form an integral part of the hollow fibrous ion-exchange polymeric membrane.

Polymeric Hollow Fibers with Porous Membrane Wall

The polymeric hollow fibers formed by methods of the present invention may preferably comprise a tubular membrane that is porous.

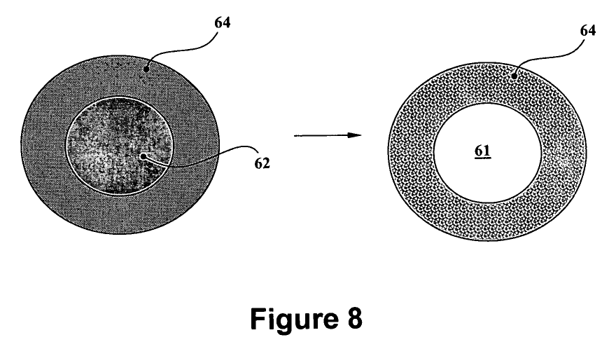

Such porous tubular membrane can be formed by a process illustrated in FIG. 8, in which a removable solid core fiber 62 formed of a removable substrate material is first provided, and a mixture 64 that comprises a polymeric membrane-forming material and a pore-forming material is then coated onto the removable solid core fiber 62, to form a fibrous precursor structure as shown at the left side of FIG. 8. The removable core fiber 62 and the pore-forming material are subsequently removed, either simultaneously or sequentially in any suitable order, leaving a porous tubular membrane structure 64, with an elongated lumen 61 therein.

The pore-forming material as used herein is preferably the same as the removable substrate material that forms the removable solid core fiber 62, so that the core fiber 62 and the pore-forming material can be simultaneously removed. Alternatively, such pore-forming material may be different from the removable substrate material in the core fiber 62, and can be removed either before or after removal of such core fiber 62.

In a specific example of the present invention, a polyvinylpyrrolidone (PVP) material is extruded into a water-soluble core fiber. A thin layer of a viscous solution that comprises a mixture of 10-30 wt % polysulfone (as the polymeric membrane-forming material) with 10-20 wt % PVP (as the pore-forming material) dissolved in 60-70% N,N-dimethylacetamide (DMAc) is extruded onto such solid PVP core fiber, to form a coated fiber. Such coated fiber is then contacted with a coagulation bath of water, in which both the solid PVP core fiber and the PVP material in the layer of the viscous solution simultaneously are simultaneously dissolved and therefore removed, forming a hollow fiber having a porous polysulfone membrane wall.

Co-extrusion Methods Based on Melt and Solution Extrusion

The present invention in a further aspect provides a co-extrusion method for forming a polymeric hollow fiber.

Specifically, a removable substrate material is provided in molten form, and a polymeric membrane-forming material is provided in a viscous solution, both of which are co-extruded into a fibrous structure. Such fibrous structure comprises a fibrous core, formed by the molten removable substrate material, and a membrane wall, formed by the viscous solution of the polymeric membrane-forming material.

The extrusion dies as shown in FIGS. 1 and 2 can also be used for co-extruding such fibrous structure. For example, the molten removable substrate material is pumped through the inner manifold of such extrusion die, and the viscous solution of the polymeric membrane-forming material is pumped through the outer (or intermediate) manifold of the extrusion die. Such extrusion dies are preferably equipped with heating devices, so as to maintain the removable substrate material as molten, and with a specific viscosity appropriate for the extrusion.

Such fibrous structure is particularly advantageous for forming a deformation-free polymeric hollow fiber, due to the fact that its fibrous core, formed by the molten removable substrate material, immediately solidifies and becomes a solid core fiber upon exposure to lower temperature after it exits the spinnerette. Such solid core fiber provides mechanical support to the relatively “softer” membrane wall of the polymeric membrane-forming material solution, during subsequent treatment thereof (i.e., coagulating and drying of such polymeric solution) and before such membrane wall attains a permanent tubular shape. After solidification of such membrane wall, the solid core fiber is selectively removed by methods described hereinabove, to form a polymeric hollow fiber having a membrane wall of a permanent tubular shape.

In a preferred embodiment of the present invention, the polymeric membrane-forming material comprises an ion-exchange polymer, such as the Nafion® membrane material, which can be co-extruded with various water-soluble removable substrate materials, such as PVP, PVA, and PEG, to form ion-exchange polymeric hollow fibers.

In another preferred embodiment of the present invention, such co-extrusion method can be used to form a polymeric hollow fiber having a porous tubular membrane wall, by:

(a) providing a molten removable substrate material;

(b) providing a viscous solution comprising a mixture of a polymeric membrane-forming material and a pore-forming material that is removable from such mixture;

(c) co-extruding the molten removable substrate material and the viscous solution, to form a fibrous structure comprising a fibrous core enclosed by a membrane wall, wherein such fibrous core is formed by the molten removable substrate material, and wherein such membrane wall is formed by the viscous solution of the mixture;

(d) cooling the fibrous structure to solidify the fibrous core formed by the molten removable substrate material;

(e) treating the fibrous structure with a coagulating agent, to solidify the membrane wall formed by the viscous solution of the mixture, forming a solidified polymeric membrane; and

(f) removing the pore-forming material and the fibrous core, to form a polymeric hollow fiber with a porous polymeric membrane.

The pore-forming material as used herein is preferably the same as the removable substrate material that forms the fibrous core of the fibrous structure, so that such fibrous core and the pore-forming material can be simultaneously removed. Alternatively, such pore-forming material may be different from the removable substrate material in the fibrous core, and can be removed either before or after removal of the fibrous core.

Further, either the pore-forming material or the removable substrate material, or both, is preferably removable by the coagulating agent (i.e., the coagulating agent concurrently functions as a removing agent). Therefore, by using such coagulating agent having material-removing capability, solidification of the membrane wall in step (e) and removal of the pore-forming material and the fibrous core in step (f) can be carried out simultaneously.

Further examples are provided hereinafter regarding fabrication of microfibrous fuel cell structures according to preferred embodiments of the present invention:

### EXAMPLE 1

Fabrication of Nafion® Hollow Fibers Using a Swelling Agent

Summary:

This example shows that a Nafion® layer could be directly extruded onto a solid core fiber to form a hollow fibrous membrane. Additionally, it shows that the hollow fiber membrane wall thickness could be adjusted from 30 to 128 μm, and the rate of membrane formation could be increased from 1 to 3 meters/min, while maintaining the desired leak-free and tensile properties. Hollow fiber samples with thicker membrane walls were significantly tougher, as evidenced by an approximately 86% increase in the strain at break when the membrane wall thickness increased from about 30 μm to about 128 μm.

Equipment and Procedure:

The extrusion system and process employed for producing the Nafion® hollow fibers in this example as well as the subsequent examples 2-6 were similar to those depicted by FIGS. 3A and 3B. The equipments used herein specifically included:

Let-off stand for the wire spool;

Single-layer extrusion die for applying Nafion® extrudate to the core wire;

Piston pump;

Two medium wave infrared (IR) dryers, each being approximately one meter long;

Belted pulling unit for moving the wire along the system; and

Take-up unit to collect the final product on a spool.

It is well known to those skilled in the art that an extrusion die can typically be operated under several configurations, including “pressure” and “sleeving/tubing” configurations. The pressure die configuration is depicted in FIGS. 1 and 2. The sleeving/tubing die configuration is similar, except that the sleeving/tubing die configuration further comprises a small hollow metal “hypotube” that covers the solid core fiber (see reference numeral 10 in FIG. 1) from the die entrance to the die exit. Thus, the polymer extrudate contacts the solid core fiber for the first time when both exit from the die. Dimensions of the hypotube are given hereinafter if a sleeving/tubing die was employed; and dimensions of the conical tip within the die are given if a pressure die was used instead.

The set-point temperature of the IR dryer is the temperature measured by the internal temperature probe near the heating elements. The actual temperature of the extruded fiber when passing through the IR dryer was considerably lower than such set-point temperature, since the IR dryer had an internal diameter of about six inches lined with heating elements. A different online drying device, such as a forced convection hot air tube, was also employed in certain examples. The set-point temperature of such hot air tube is the air temperature, which was approximately the same as the actual temperature of the extruded fiber.

A 36.9 wt % Nafion® dispersion extrudate was obtained by evaporating a 20 wt % Nafion® 1100EW dispersion (DuPont Fluoroproducts, Fayetteville, N.C.) in a mixture of alcohols and water. The concentrated 36.9 wt % Nafion® dispersion had a shear viscosity of about 1800 Poise, as measured with a rotational viscometer (Brookfield LVT model) with a #4 spindle at 3 rpm and ambient conditions. Such concentrated 36.9 wt % Nafion® dispersion extrudate was extruded around a 304-grade stainless steel wire core of an approximately 0.020′ outer diameter (OD) at ambient conditions of 23° C. and 13% relative humidity, to form a Nafion® membrane layer. In this example, different Nafion® membrane layers of different thickness were formed by adjusting the extrusion rate and line speed. The Nafion® membrane layer was subsequently dried online by the two medium wave IR dryers described hereinabove and collected onto a spool.

The spooled Nafion® membrane with the wire core was cut into 12-inch-long fibers and heat-treated sequentially at: (1) 70° C. for 15 minutes, (2) 100° C. for 15 minutes, and (3) 120° C. for 1 hour. The fibers were then immersed into water at room temperature for about 10-20 minutes, which caused the Nafion® membrane layer to swell and become detached from the 0.020″ wire core. The detached 0.020″ wire core was then extracted to from a hollow Nafion® fiber.

The extrusion parameters and the dimensions of the Nafion® hollow fibers are specified in Tables I and II, as follows:

TABLE I

| | |
|---|---|
| Polymer Extrudate | Nafion ® - 36.9 wt % |
| Die Configuration | Sleeving |
| Extrusion Die Hole | 0.052″ |
| Hypotube ID × OD | 0.023″ × 0.032″ |
| IR Dryer #1 Set Point Temp. | 375° C. |
| IR Dryer #2 Set Point Temp. | 450° C. |

TABLE II

| Line | Extrusion | Extrusion | Wall | | | Leak- | Strain at | Tensile |
|---|---|---|---|---|---|---|---|---|
| Speed | Rate | Amount | Thickness | | ID | free | Break | Strength |
| (m/min) | (mL/min) | (mL/m) | (μm) | OD (μm) | (μm) | (%) | (%) | (psi) |
| 1 | 0.34 | 0.34 | 49 | 590 | 493 | 100 | 210 | 4000 |
| 2 | 0.68 | 0.34 | 49 | 593 | 495 | 80 | 180 | 3200 |
| 3 | 1.03 | 0.34 | 47 | 582 | 488 | 100 | 170 | 4100 |
| 1 | 1.03 | 1.03 | 128 | 750 | 495 | 100 | 280 | 4050 |
| 2 | 1.03 | 0.52 | 67 | 623 | 490 | 100 | 260 | 4200 |
| 3 | 0.68 | 0.23 | 30 | 555 | 495 | 97 | 150 | 3500 |

The wall thickness, outer diameter (OD) and inner diameter (ID) of the Nafion® hollow fibers were determined by cross-sectional microscopic examination of such hollow fibers. There were up to 10 μm discrepancy between the given wall thickness and that calculated by subtracting the ID from the OD, since the wall was examined under a higher magnification (40×), while the diameters were measured at a relatively lower magnification (10×).

Each Nafion® hollow fiber so formed was checked for leakage, by flowing water through the fiber's bore at approximately 1 mL/second. The leak-free percentage of the Nafion® hollow fibers was calculated by dividing the number of fibers having zero leakage along the entire 12-inch length over the total number of fibers tested. Nominally, about 9-30 fibers were tested for leakage during each run.

The axial (i.e., longitudinal) tensile properties of the dried Nafion® hollow fibers were determined at ambient conditions by using a Com-Ten Industries, 95 Series tensile tester, with an effective gauge length of 4 inches and a strain rate of 100% per minute. Nominally, about 5-15 Nafion® hollow fibers were tested for tensile strength during each run.

### EXAMPLE 2

Fabrication of Nafion® Hollow Fibers Using Various Extrudates

Summary:

This example shows that different polymeric extrudates having significantly different viscosity can be used to form hollow fibrous membranes.

Equipment and Procedure:

Two different Nafion® dispersion extrudates were extruded onto 0.020″ OD 304 stainless steel wire cores to form two lots of Nafion® membranes. The pressure die configuration, as opposed to the sleeving die configuration, was used for both lots.

The first extrudate used was a 29.2 wt % Nafion® dispersion that was obtained via evaporation method as described in Example 1. Such 29.2 wt % Nafion® dispersion extrudate had a shear viscosity of about 230 Poise at 3 rpm. The second extrudate was a 34.0 wt % Nafion® dispersion having a shear viscosity of about 17,600 Poise at 0.3 rpm, which is equivalent to about 4,000 Poise at 3 rpm according to a power law relation. The upper limit for the Brookfield LVT viscometer is 2000 Poise for spindle #4 at 3rpm, thus the power law relation was necessary to compare the viscosities of the two Nafion® dispersion extrudates.

Both Nafion® extrusion runs were performed at an ambient temperature of about 23° C. and 44% relative humidity. The Nafion® membrane layer formed by each extrudate was dried online by a forced convection hot air tube (about one meter long) and collected onto a spool. The spooled Nafion® membrane with the wire core was then cut into 6-inch-long fibers, heat-treated as described hereinabove in Example 1, immersed into water at room temperature for about 10-20 min, and the 0.020″ wire cores were subsequently extracted to form Nafion® hollow fibers.

The extrusion parameters and dimensions of the Nafion® hollow fibers from both lots are specified hereinafter in Table III. The fiber dimensions were determined by the same techniques as described in Example 1. For determining the tensile properties, about 6-8 Nafion® hollow fibers were tested for each lot.

TABLE III

| | Lot #1 | Lot #2 |
|---|---|---|
| Nafion ® Extrudate (wt %) | 29.2 | 34.0 |
| Nafion ® Extrudate Viscosity | 230 | ˜4,000 |
| (Poise at 3 rpm) | | |

| | |
|---|---|
| Die Configuration | Pressure |
| Extrusion Die Hole (inch) | 0.034 |
| Pressure Tip ID (inch) | 0.022 |
| Extrusion Rate (mL/min) | 0.35 |
| Hot Air Dryer Set Point | 110 |
| Temp. (° C.) | |
| Line Speed (m/min) | 0.75 |

| | | |
|---|---|---|
| Wall Thickness (μm) | 49 | 59 |
| OD (μm) | 597 | 587 |
| ID (μm) | 500 | 470 |
| Strain at Break (%) | 68 | 106 |
| Tensile Strength (psi) | 1900 | 2500 |

### EXAMPLE 3

Fabrication of Nafion® Hollow Fibers Using Removable PVP Substrate Layer

Summary:

This example illustrates the use of a removable PVP substrate layer. It further shows that the Nafion® membrane layer can be dried by either an IR dryer or a hot air convection tube.

Equipment and Procedure:

A polyvinyl pyrrolidone (PVP) extrudate (Luvitec K60, 45 wt %, BASF, Mt. Olive, N.J.) was used to form a removable substrate layer over a 0.020″ OD 304 stainless steel wire core. The PVP extrusion process was performed at ambient condition, and the extruded PVP layer was dried by a medium wave IR dryer, forming a PVP coating of 50±10 μm thick (as determined by micrometer and microscope measurements) and collected onto a spool.

The PVP-coated wire core was subsequently unspooled and coated with a 37.4 wt % Nafion® dispersion extrudate. The 37.4 wt % Nafion® dispersion extrudate was obtained by evaporate method as described in Example 1 and had a shear viscosity of about 1620 Poise at 3 rpm. The Nafion® extrusion process was performed at ambient conditions of 23° C. and 19% relative humidity. The extruded Nafion® membrane layer was dried online with either an IR dryer or a forced convection hot air tube, each being about one meter long and then collected onto a spool. The spooled Nafion®-PVP-wire-core structure was cut into 12-inch-long fibers and heat-treated, as described in Example 1. These fibers were then immersed into water at room temperature for about 10-20 minutes, allowing extraction of the 0.020″ wire core. The hollow fibers were then immersed in boiling water for about 30-40 minutes to remove the PVP substrate layer.

Details regarding the PVP and Nafion® extrusion processes and the dimensions of the Nafion® hollow fibers are specified in Table 4, as follows.

TABLE IV

| | PVP Extrusion | Nafion ® Extrusion | |
|---|---|---|---|
| Extrudate | PVP K60 - 45 wt % | Nafion ® - 37.4 wt % | |
| Die Configuration | Sleeving | Sleeving | |
| Extrusion Die Hole | 0.053″ | 0.064″ | |
| Hypotube ID × OD | 0.023″ × 0.032″ | 0.033″ × 0.0425″ | |
| Extrusion Rate (mL/min) | 0.54 | 0.41 | |
| Line Speed (m/min) | 3 | 1 | |
| Set Point Temp. (° C.) | 425 (IR Dryer) | IR | Hot Air |
| | | Dryer | Dryer |
| | | 375 | 110 |

| | | |
|---|---|---|
| Coating Thickness (μm) | 50 | 48 |
| OD (μm) | 610 | 668 |
| ID (μm) | 508 | 571 |

| | | |
|---|---|---|
| Strain at Break (%) | 78 | 55 |
| Tensile Strength (psi) | 4000 | 3800 |

The fiber properties were determined as described in Example 1. Specifically, the dimensions of the PVP layer were determined before extraction of the wire core, while the dimensions of the Nafion® layer were determined after extraction of the wire core, removal of the PVP layer, and drying of the Nafion® layer. The Nafion® membrane layers dried by the hot air dryer and the IR dryer were characterized by similar dimensions.

### EXAMPLE 4

Fabrication of Nafion® Hollow Fibers Using PVP-PVA Double Removable Substrate Layers

Summary:

This example illustrates that multiple layers of PVP, polyvinyl alcohol (PVA), and Nafion® can be coated on top of one another to form the desired Nafion® hollow fibers. Further, this example shows that the removable substrate layer can be formed by PVA as well as PVP.

Equipment and Procedure:

Three lots of membrane structures were formed over respective wire cores, which contained one to four layers of polymeric materials, including: (1) a single Nafion® layer, (2) double Nafion® layers coated over a PVP layer, and (3) double Nafion® layers coated over a removable PVP-PVA double-layer substrate.

The Nafion® dispersion extrudates were prepared as in Example 1, and the PVP extrudate was the same as that used in Example 3. An aqueous PVA extrudate was prepared by dissolving 13 wt % of the PVA polymer (Elvanol, grade 70-62, from DuPont) in hot water while stirring. All extrusion runs were performed at ambient conditions. The PVP and Nafion® layers for Lots #(2) and #(3) were extruded under identical conditions. The PVA layer in Lot #(3) was dried by two sequentially arranged IR dryers, due to the low solid content in the PVA extrudate.

For each of the above-described membrane structures (i.e., Lots #(1)-(3)), once all the polymeric material layers required for such membrane structure were formed over the wire core, the spooled membrane structure was cut into 12-inch-long fibers, heat-treated, and immersed into water at room temperature to remove the wire core, as described in Example 1. A hot or boiling water bath was used to remove the PVP and PVA layers. The wall thickness, OD and ID of the PVP and PVA layers were determined by microscopic examination before removal of the wire core. The corresponding dimensions of the Nafion® layer were determined after the PVA and PVP layers had been removed.

Extrusion parameters and dimensional details of each membrane structure are specified in Tables V-VII below:

TABLE V
(LOT #1: SINGLE NAFION ® LAYER)

| Polymer Extrudate | Nafion ® - 32 wt % |
|---|---|
| Die Configuration | Sleeving |
| Extrusion Die Hole | 0.053″ |
| Hypotube ID × OD | 0.026″ × 0.0355″ |
| Extrusion Rate (mL/min) | 0.43 |
| IR Dryer Set Point Temp (° C.) | 375 |
| Line Speed (m/min) | 1 |
| Wall Thickness (μm) | 50 |
| OD (μm) | 600 |
| ID (μm) | 520 |

TABLE VI
(LOT #2: DOUBLE NAFION ® LAYERS
OVER A PVP LAYER)

| | PVP Layer | 1^{st} Nafion ® Layer | 2^{nd} Nafion ® Layer |
|---|---|---|---|
| Extrudate | Luvitec ® K60 - | Nafion ® - 31.5 wt % | Nafion ® - 32 wt % |
| | 45 wt % | | |
| Die Configuration | Sleeving | Pressure | Sleeving |
| Extrusion Die Hole | 0.053″ | 0.034″ | 0.053″ |
| Hypotube ID × OD or | 0.023″ × 0.032″ | 0.027″ | 0.031″ × 0.0355″ |
| Pressure Tip ID | | | |
| Extrusion Rate (mL/min) | 0.54 | 0.92 | 0.48 |
| IR Dryer Set Point Temp. | 425° C. | 400° C. | 375° C. |
| Line Speed (m/min) | 3 | 2 | 1 |

| | | |
|---|---|---|
| Wall Thickness (μm) | 55 | 90 |
| OD (μm) | 610 | 760 |
| ID (μm) | 500 | 570 |

TABLE VII
(LOT #2: DOUBLE NAFION ® LAYERS
OVER PVP AND PVA LAYERS)

| | PVP Layer | PVA Layer | 1^{st} Nafion ® layer | 2^{nd} Nafion ® layer |
|---|---|---|---|---|
| Polymer extrudate | Luvitec ® K60 | Elvanol ® PVA - | Nafion ® | Nafion ® |
| | 45 wt % | 13 wt % | 31.5 wt % | 32 wt % |
| Die Configuration | Sleeving | Pressure | Pressure | Sleeving |
| Extrusion Die Hole | 0.053″ | 0.034″ | 0.034″ | 0.053″ |
| Hypo-tube ID × OD or | 0.023″ × 0.032″ | 0.032″ | 0.027″ | 0.031″ × 0.0355″ |
| Pressure Tip ID | | | | |
| Extrusion Rate (mL/min) | 0.54 | 0.23 | 0.92 | 0.48 |
| IR Dryer Set Point | 425° C. | 425° C. | 400° C. | 375° C. |
| Temp. | | | | |
| Line Speed (m/min) | 3 | 1 | 2 | 1 |

| | | | |
|---|---|---|---|
| Wall Thickness (μm) | 55 | 10 | 100 |
| OD (μm) | 610 | 625 | 780 |
| ID (μm) | 500 | 500 | 565 |

### EXAMPLE 5

Fabrication of Fiberglass-reinforced Hollow Fibers

Summary:

This example illustrates fabrication of fiberglass-reinforced Nafion® hollow fibers, using the above described techniques with minimal adjustments.

Equipment and Procedure:

A first Nafion® layer was extruded onto a 0.020″ OD 304 stainless steel wire core, dried and collected onto a spool. A second Nafion® layer was subsequently extruded on top of the first Nafion® layer, with a fiberglass yarn being incorporated between such two Nafion® layers. The resulting fiberglass-reinforced Nafion® hollow fibers displayed tensile strength approximately 7 times greater than that of the typical Nafion® hollow fibers, and negligible axial or longitudinal expansion upon contact with water.

Specifically, a first Nafion® dispersion extrudate containing 38.5 wt % Nafion® (obtained via evaporation as described in Example 1) and having a shear viscosity of about 1800 Poise at 3 rpm was extruded onto the 0.020″ OD 304 stainless steel wire core. The first extrusion process was performed at ambient conditions of 25° C. and 16% relative humidity. The first Nafion@ membrane layer so formed was dried online by a forced convection hot air tube of about 1 meter long.

A second Nafion® dispersion extrudate containing about 37.5 wt % Nafion® was also obtained via evaporation as described in Example 1, such second extrudate having a shear viscosity of about 1260 Poise at 3 rpm. A bobbin of fiberglass yarn (identified as product “G37 1/0 1.0Z 690/31”) was obtained from PPG Industries (Lexington, N.C.). The yam consisted of approximately 800 filaments having 11 μm OD.

The second extrusion process was performed at ambient conditions of 24° C. and 19% relative humidity. The fiberglass yarn and the wire core coated with the first Nafion® membrane layer were concurrently fed through the hypotube of a sleeving extrudate die. The 37.5 wt % Nafion® dispersion extrudate was then extruded from the die to encapsulate the fiberglass yarn and the coated wire core. An applied tension forced the yam to lay flat against the extruded fiber and to cover a significant portion of the circumference of such fiber. Fibers without the fiberglass yarn were also formed for comparison. The fiberglass-reinforced Nafion® membrane structure was dried online by a medium wave IR dryer of about 1 meter long, collected onto a spool and then cut into 12-inch-long fibers. The fibers were then heat-treated as described in Example 1 and immersed into water at room temperature for about 10-20 minute, allowing the 0.020′ wire core to be extracted to form Nafion® hollow fibers.

The extrusion parameters and fiber properties are specified in Table VIII below:

TABLE VIII

| | |
|---|---|
| 1^{st} Nafion ® layer | 2^{nd} Nafion ® layer |

| | | | |
|---|---|---|---|
| Extrudate | Nafion ® - 38.5 wt % | Nafion ® - 37.5 wt % | |
| Die Configuration | Sleeving | Sleeving | |
| Extrusion Die Hole | 0.064″ | 0.075″ | |
| Hypo-tube ID × OD | 0.033″ × 0.0425″ | 0.052″ × 0.059″ | |
| | | w/o fiberglass | with fiberglass |
| Extrusion Rate (mL/min) | 0.26 | 0.35 | 0.6 |
| Dryer Set Point Temp. (° C.) | 110 (Hot Air Dryer) | 375 (IR Dryer) | 375 (IR Dryer) |
| Line Speed (m/min) | 1.0 | 0.5 | 0.5 |
| Wall Thickness (μm) | 51 | 120 | 125-395 |
| OD (μm) | 597 | 747 | 930 |
| ID (μm) | 495 | 492 | 485 |
| Axial Swelling (%) | 6 ± 2 | 7 ± 1 | <0.5 |
| Strain at Break (%) | 100 | 200 | ˜8 |
| Tensile Strength (psi) | 2,500 | 3,400 | >24,800 |

Dimensions of the hollow fibers were determined after removal of the wire core and drying of the hollow fibers, as described hereinabove in Example 1. The imbedded fiberglass yarn covered approximately ¼ of the circumference of the hollow fiber so formed, and increased the wall thickness of such fiber. Ten 12-inch-long fiberglass-reinforced Nafion® hollow fibers were tested for axial (or longitudinal) swelling and tensile properties. The difference between the dry and wet lengths of the fiberglass-reinforced Nafion® hollow fibers were within 2 mm, or 0.5% of the total length, while the pure Nafion® hollow fibers typically swelled about 20 mm, or 6-7% of the total length.

Two of the ten fiberglass-reinforced Nafion® hollow fibers overloaded the 20-pound test cell of the tensile tester. The remaining eight fibers were averaged to provide the strain and strength data shown in Table VIII hereinabove. The typical maximum load of a fiberglass-reinforced Nafion® hollow fiber was about 18-19 lbs of force. The fiberglass yam alone held a maximum load of 16-18 lbs with a 5% strain at break.

### EXAMPLE 6

Fabrication of Nafion® Hollow Fibers Using PVA Core Fiber

Summary:

This example demonstrates the use of a solid core fiber made of a water-soluble substrate material in forming Nafion® hollow fibers.

Equipment and Procedure:

A bobbin of PVA yarn was obtained from Nitivy Company Ltd (Tokyo, Japan) as the product Solvron® MH750 dtex. Such PVA yarn is soluble in 95° C. water and comprises continuous filaments of about 15.60 μm (˜0.0125″) in OD. The PVA yarn was used as received except that it was transferred from the bobbin to a spool to facilitate application of tension during extrusion. A 37.5 wt % Nafion® dispersion having a shear viscosity of approximately 2050 Poise at 3 rpm was obtained via evaporation as described in Example 1. Such Nafion® dispersion was extruded onto the PVA yarn, dried online, and collected onto a spool.

Three lots of Nafion®-coated PAV fibers were formed, each having a Nafion® coating of different thickness, as obtained by adjusting the flow rate of the Nafion® extrudate. The extrusion setup was the same as that described in Example 1, and the runs were all performed at ambient conditions at 23° C. and with 11% relative humidity. Once extruded onto the PVA yarn, the Nafion® coating was dried online by one IR dryer set at 375° C., and such Nafion®-coated PAV fiber was spooled. The spooled fiber was subsequently unspoiled, cut into 12-inch-long fibers, and heat-treated as described in Example 1. The fibers were immersed into two sequential boiling water baths for about 1 hour each to dissolve and remove the PVA core fibers and form Nafion® hollow fibers.

The Nafion® hollow fibers so formed were characterized by high leak-free percentages and advantageous tensile properties (see the tables below), similar to those formed with a stainless steel wire core in Example 1. More details regarding the extrusion process and the fiber properties are given in Table IX and Table X as follows:

TABLE IX

| Extrudate | Nafion ® - 37.5 wt % |
|---|---|
| Die Configuration | Sleeving |
| Extrusion Die Hole | 0.052″ |
| Hypotube ID × OD | 0.023″ × 0.032″ |
| IR Dryer Set Point (° C.) | 375 |
| Line Speed (m/min) | 0.5 |

TABLE X

| | Lot #1 | Lot #2 | Lot #3 |
|---|---|---|---|
| Extrusion Rate (mL/min) | 0.20 | 0.12 | 0.45 |
| Wall Thickness (μm) | 85 | 40 | 130 |
| OD (μm) | 460 | 400 | 570 |
| ID (μm) | 295 | 315 | 305 |
| Leak-Free Percentage (%) | 100 | 80 | 100 |
| Strain at Break (%) | 110 | 50 | 100 |
| Tensile Strength (psi) | 3900 | 4400 | 4700 |

The hollow fiber dimensions were determined by examining three cross-sections per lot. The fibers were verified to be hollow and leak-checked by syringing water through the lumen at 2-3 mL/min for ten samples per lot. The tensile properties were determined by averaging five samples from each lot.

While the invention has been described herein with reference to specific embodiments, features and aspects, it will be recognized that the invention is not thus limited, but rather extends in utility to other modifications, variations, applications, and embodiments, and accordingly all such other modifications, variations, applications, and embodiments are to be regarded as being within the spirit and scope of the invention.

What is claimed is:

1. A method for forming a polymeric hollow fiber, comprising the steps of:
(a) providing a solid core fiber;
(b) coating at least one layer of a removable substrate material over said solid core fiber;
(c) coating at least one layer of a polymeric membrane-forming material over said removable substrate material layer;
(d) treating said polymeric membrane-forming material layer to form a solidified polymeric membrane; and
(e) removing the removable substrate material layer and the solid core fiber from the solidified polymeric membrane, to form a polymeric hollow fiber comprising a tubular membrane wall enclosing an elongated lumen therein.

2. The method of claim 1, wherein said removable substrate material comprises material selected from the group consisting of sublimable materials, meltable materials, and soluble materials.

3. The method of claim 1, wherein said removable substrate material comprises soluble material selected from the group consisting of acid-soluble materials, alkali-soluble materials, organic-solvent-soluble materials, and water-soluble materials.

4. The method of claim 1, wherein said removable substrate material comprises water-soluble polymeric material selected from the group consisting of polyvinyl pyrrolidones (PVP), polyvinyl alcohols (PVA), and polyethylene glycols (PEG).

5. The method of claim 1, wherein said solid core fiber comprises material selected from the group consisting of metals, metal alloys, glass, ceramics, carbons, polymers, and mixtures thereof.

6. The method of claim 1, wherein said solid core fiber has a cross-sectional outer diameter in a range of from about 10 microns to about 10 millimeter.

7. The method of claim 1, wherein said polymeric membrane-forming material comprises polymeric material selected from the group consisting of polysulfone, polypropylene, polyacrylonitrile, polytetrafluoroethylene, polyethylene, polyvinylidene fluoride, polyamide, polyethyl methacralyte, regenerated cellulose acetate, cellulose triacetate, and mixtures thereof.

8. The method of claim 1, wherein said polymeric membrane-forming material comprises ion-exchange polymeric material selected from the group consisting of perfluorocarbon-sulfonic-acid-based polymers, polysulfone-based polymers, perfluorocarboxylic-acid-based polymers, styrene-vinyl-benzene-sulfonic-acid-based polymers, styrene-butadiene-based polymers, and mixtures thereof.

9. The method of claim 1, wherein said polymeric membrane-forming material comprises perfluorosulfonate ionomer.

10. The method of claim 9, wherein said perfluorosulfonate ionomer is solution extruded over said removable substrate material layer.

11. The method of claim 10, wherein the treatment of said perfluorosulfonate ionomer comprises the steps of: (i) drying said perfluorosulfonate ionomer at a first elevated temperature; and (ii) curing said perfluorosulfonate ionomer at a second elevated temperature.

12. The method of claim 11, wherein the first elevated temperature is in a range of from about 25° C. to about 100° C.

13. The method of claim 11, wherein the second elevated temperature is in a range of from about 110° C. to about 250° C.

14. The method of claim 1, wherein one or more reinforcing fibers are incorporated into said at least one polymeric membrane-forming material layer to form a fiber-reinforced polymeric membrane.

15. The method of claim 14 wherein the solid core fiber has a longitudinal axis, and wherein said reinforcing fibers extend continuously along the longitudinal axis of said solid core fiber.

16. The method of claim 14 wherein said reinforcing fibers comprises fibers selected from the group consisting of fiberglass, carbon fibers, metal fibers, resin fibers, and composite fibers.

17. The method of claim 14, wherein said reinforcing fibers comprises fiberglass yarns.

18. The method of claim 17, wherein said fiber glass yarns are characterized by an average outer diameter in a range of from about 0.1 μm to about 500 μm.

19. The method of claim 14, wherein said reinforcing fibers are co-extruded with said polymeric membrane-forming material layer.

20. The method of claim 14, wherein two layers of polymeric membrane-forming material are coated over said removable substrate material layer, and wherein said reinforcing fibers are encapsulated between said two polymeric membrane-forming material layers.

21. The method of claim 1, further comprising the step of providing a removal interface in contact with at least a portion of the removable substrate material layer, to facilitate removal of said removable substrate material.

22. The method of claim 21, wherein said removal interface comprises an open cavity, through which a removing fluid can be passed through to remove said removable substrate material.

23. A method for forming a polymeric hollow fiber, comprising the steps of:
(a) providing a solid core fiber comprising removable substrate material;
(b) coating at least one layer of polymeric membrane-forming material over said solid core fiber;
(c) treating said polymeric membrane-forming material layer to form a solidified polymeric membrane; and
(d) removing the solid core fiber from the solidified polymeric membrane, to form a polymeric hollow fiber comprising a tubular membrane wall enclosing an elongated lumen therein.

24. The method of claim 23, wherein said removable substrate material comprises material selected from the group consisting of sublimable materials, meltable materials, and soluble materials.

25. The method of claim 23, wherein said removable substrate material comprises soluble material selected from the group consisting of acid-soluble materials, alkali-soluble materials, organic-solvent-soluble materials, and water-soluble materials.

26. The method of claim 23, wherein said removable substrate material comprises water-soluble polymeric material selected from the group consisting of polyvinyl pyrrolidones (PVP), polyvinyl alcohols (PVA), and polyethylene glycols (PEG).

27. The method of claim 23, wherein said solid core fiber has a cross-sectional outer diameter in a range of from about 10 microns to about 10 millimeter.

28. The method of claim 23, wherein said polymeric membrane-forming material comprises polymeric material selected from the group consisting of polysulfone, polypropylene, polyacrylonitrile, polytetrafluoroethylene, polyethylene, polyvinylidene fluoride, polyamide, polyethyl methacralyte, regenerated cellulose acetate, cellulose triacetate, and mixtures thereof.

29. The method of claim 23, wherein said polymeric membrane-forming material comprises ion-exchange polymeric material selected from the group consisting of perfluorocarbon-sulfonic-acid-based polymers, polysulfone-based polymers, perfluorocarboxylic-acid-based polymers, styrene-vinyl-benzene-sulfonic-acid-based polymers, styrene-butadiene-based polymers, and mixtures thereof.

30. The method of claim 23, wherein said polymeric membrane-forming material comprises perfluorosulfonate ionomer.

31. The method of claim 30, wherein said perfluorosulfonate ionomer is solution extruded over said removable substrate material layer.

32. The method of claim 31, wherein the treatment of said perfluorosulfonate ionomer comprises the steps of: (i) drying said perfluorosulfonate ionomer at a first elevated temperature; and (ii) curing said perfluorosulfonate ionomer at a second elevated temperature.

33. The method of claim 32, wherein the first elevated temperature is in a range of from about 25° C. to about 100° C.

34. The method of claim 32, wherein the second elevated temperature is in a range of from about 110° C. to about 250° C.

35. The method of claim 23, wherein one or more reinforcing fibers are incorporated into said at least one polymeric membrane-forming material layer to form a fiber-reinforced polymeric membrane.

36. The method of claim 35, wherein the solid core fiber has a longitudinal axis, and wherein said reinforcing fibers extend continuously along the longitudinal axis of said solid core fiber.

37. The method of claim 35, wherein said reinforcing fibers comprises fibers selected from the group consisting of fiberglass, carbon fibers, metal fibers, resin fibers, and composite fibers.

38. The method of claim 35, wherein said reinforcing fibers comprises fiberglass yarns.

39. The method of claim 38, wherein said fiberglass yarns are characterized by an average outer diameter in a range of from about 0.1 μm to about 500 μm.

40. The method of claim 35, wherein said reinforcing fibers are co-extruded with said polymeric membrane-forming material layer.

41. The method of claim 35, wherein two layers of polymeric membrane-forming material are coated over said solid core fiber, and wherein said reinforcing fibers are encapsulated between said two polymeric membrane-forming material layers.

42. The method of claim 23, further comprising the step of providing a removal interface in contact with at least a portion of said solid core fiber, to facilitate removal thereof.

43. The method of claim 42, wherein said removal interface comprises an open cavity inside the solid core fiber, for passing a removing fluid therethrough to remove the solid core fiber.

44. A method for forming a polymeric hollow fiber, comprising the steps of:
(a) providing a solid core fiber;
(b) coating at least one layer of swellable polymeric membrane-forming material over said solid core fiber;
(c) treating said swellable polymeric membrane-forming material layer to form a solidified polymeric membrane;
(d) contacting said solidified polymeric membrane with a swelling agent to effectuate expansion and disengagement of such polymeric membrane from the solid core fiber; and
(e) removing the solid core fiber from the disengaged solidified polymeric membrane, to form a polymeric hollow fiber comprising a tubular membrane wall enclosing an elongated lumen therein.

45. The method of claim 44, wherein said solid core fiber comprises material selected from the group consisting of metals, metal alloys, glass, ceramics, carbons, polymers, and mixtures thereof.

46. The method of claim 44, wherein said solid core fiber has a cross-sectional outer diameter in a range of from about 10 microns to about 10 millimeter.

47. The method of claim 44, wherein said swellable polymeric membrane-forming material comprises ion-exchange polymeric material selected from the group consisting of perfluorocarbon-sulfonic-acid-based polymers, polysulfone-based polymers, perfluorocarboxylic-acid-based polymers, styrene-vinyl-benzene-sulfonic-acid-based polymers, styrene-butadiene-based polymers, and mixtures thereof.

48. The method of claim 44, wherein said swelling agent comprises water or an organic solvent.

49. The method of claim 44, wherein polymeric membrane-forming material comprises perfluorosulfonate ionomer, and wherein said swellable agent comprises water.

50. The method of claim 44, wherein one or more reinforcing fibers are incorporated into said at least one swellable polymeric membrane-forming material layer to form a fiber-reinforced polymeric membrane.

51. The method of claim 50, wherein the solid core fiber has a longitudinal axis, and wherein said reinforcing fibers extend continuously along the longitudinal axis of said solid core fiber.

52. The method of claim 50, wherein said reinforcing fibers comprises fibers selected from the group consisting of fiberglass, carbon fibers, metal fibers, resin fibers, and composite fibers.

53. The method of claim 50, wherein said reinforcing fibers comprises fiberglass yarns having an average outer diameter in a range of from about 0.1 μm to about 500 μm.

54. The method of claim 50, wherein said reinforcing fibers are co-extruded with said swellable polymeric membrane-forming material layer.

55. The method of claim 50, wherein two layers of swellable polymeric membrane-forming material are coated over said solid core fiber, and wherein said reinforcing fibers are encapsulated between said two swellable polymeric membrane-forming material layers.

56. A method for forming an ion-exchange polymeric hollow fiber, comprising the steps of:
(a) providing a solid core fiber that is subsequently and selectively removable;
(b) coating at least one layer of ion-exchange polymeric membrane-forming material over the solid core fiber;
(c) treating such ion-exchange polymeric membrane-forming material layer to form a solidified ion-exchange polymeric membrane; and
(d) removing the solid core fiber from the solidified ion-exchange polymeric membrane, so as to form an ion-exchange polymeric hollow fiber having a tubular membrane wall enclosing an elongated lumen therein.

57. The method of claim 56, wherein said solid core fiber comprises removable substrate material.

58. The method of claim 56, wherein said solid core fiber is coated with removable substrate material.

59. The method of claim 56, wherein the ion-exchange polymeric membrane-forming material comprises material selected from the group consisting of perfluorocarbon-sulfonic-acid-based polymers, polysulfone-based polymers, perfluorocarboxylic-acid-based polymers, styrene-vinyl-benzene-sulfonic-acid-based polymers, styrene-butadiene-based polymers, and mixtures thereof.

60. The method of claim 56, wherein one or more reinforcing fibers are incorporated into said at least one ion-exchange polymeric membrane-forming material layer to form a fiber-reinforced ion-exchange polymeric membrane.

61. The method of claim 60, wherein the solid core fiber has a longitudinal axis, and wherein said reinforcing fibers extend continuously along the longitudinal axis of said solid core fiber.

62. The method of claim 60, wherein said reinforcing fibers comprises fibers selected from the group consisting of fiberglass, carbon fibers, metal fibers, resin fibers, and composite fibers.

63. The method of claim 60, wherein said reinforcing fibers comprises fiberglass yarns having an average outer diameter in a range of from about 0.1 μm to about 500 μm.

64. The method of claim 60, wherein said reinforcing fibers are co-extruded with said ion-exchange polymeric membrane-forming material layer.

65. The method of claim 60, wherein two layers of ion-exchange polymeric membrane-forming material are coated over said solid core fiber, and wherein said reinforcing fibers are encapsulated between said two ion-exchange polymeric membrane-forming material layers.

66. A method for forming a polymeric hollow fiber, comprising the steps of:
(a) providing a solid core fiber that is subsequently and selectively removable;
(b) coating at least one layer of a mixture over the solid core fiber, wherein said mixture comprises polymeric membrane-forming material and removable pore-forming material;
(c) treating such mixture layer to form a solidified membrane structure; and
(d) removing the solid core fiber from the solidified membrane structure; and
(e) removing the pore-forming material from the solidified membrane structure, to form a polymeric hollow fiber having a porous tubular membrane wall enclosing an elongated lumen therein,
wherein steps (d) and (e) is carried out either simultaneously, or sequentially in any order.

67. The method of claim 66, wherein said solid core fiber comprises removable substrate material.

68. The method of claim 67, wherein the removable substrate material is essentially the same as the removable pore-forming material, and wherein removal of the solid core fiber is carried out simultaneously with removal of the pore-forming material.

69. A polymeric hollow fiber precursor, comprising:
(a) a solid core fiber comprising at least one removable substrate material; and
(b) a layer of polymeric membrane-forming material coated over said solid core fiber, wherein said solid core fiber is subsequently and selectively removable for forming a polymeric hollow fiber comprising a tubular polymeric membrane enclosing an elongated lumen therein.

70. A polymeric hollow fiber precursor, comprising:
(a) a solid core fiber;
(b) a layer of removable substrate material coated over said solid core fiber; and
(b) a layer of polymeric membrane-forming material coated over said removable substrate material layer,
wherein said solid core fiber and said removable substrate material layer are subsequently removable for forming a polymeric hollow fiber comprising a tubular polymeric membrane enclosing an elongated lumen therein.

71. A method for forming a fiber-reinforced polymeric hollow fibrous membrane, comprising the steps of:
(a) providing a solid core fiber that is subsequently and selectively removable, wherein said solid core fiber has a longitudinal axis;
(b) forming one or more layers of polymeric membrane-forming material over the solid core fiber, wherein said polymeric membrane-forming material layers contain one or more reinforcing fibers extending continuously along the longitudinal axis of the solid core fiber;
(c) treating said one or more polymeric membrane-forming material layers to form a solidified fiber-reinforced polymeric membrane; and
(d) removing the solid core fiber from said polymeric membrane, so as to form a fiber-reinforced polymeric hollow fiber having a tubular membrane wall enclosing an elongated lumen therein.

72. A polymeric hollow fiber precursor, comprising:
(a) a solid core fiber having a longitudinal axis; and
(b) one or more layers of polymeric membrane-forming material coated over said solid core fiber,
wherein said one or more polymeric membrane-forming material layers contain one or more reinforcing fibers extending continuously along the longitudinal axis of the solid core fiber, and wherein said solid core fiber is subsequently and selectively removable for forming a fiber-reinforced polymeric hollow fiber comprising a tubular polymeric membrane enclosing an elongated lumen therein.

73. A method for forming a polymeric hollow fiber, comprising the steps of:
(a) providing a molten removable substrate material;
(b) providing a viscous solution of polymeric membrane-forming material;
(c) co-extruding the molten removable substrate material and the viscous solution of the polymeric membrane-forming material, to form a fibrous structure comprising a fibrous core enclosed by a membrane wall, wherein said fibrous core is formed by the molten removable substrate material, and wherein said membrane wall is formed by the viscous solution of the polymeric membrane-forming material;
(d) cooling the fibrous structure to solidify said fibrous core;
(e) subsequently, treating the fibrous structure to solidify the membrane wall; and
(f) removing the fibrous core from the solidified membrane wall, forming a polymeric hollow fiber having a tubular membrane wall enclosing an elongated lumen therein.

74. The method of claim 73, wherein said polymeric. membrane-forming material comprises ion-exchange polymeric material.

75. A method for forming a polymeric hollow fiber, comprising the steps of:
(a) providing a molten removable substrate material;
(b) providing a viscous solution comprising a mixture of polymeric membrane-forming material with removable pore-forming material;
(c) co-extruding the molten removable substrate material and the viscous solution, to form a fibrous structure comprising a fibrous core enclosed by a membrane wall, wherein such fibrous core is formed by the molten removable substrate material, and wherein such membrane wall is formed by the viscous solution of the mixture;
(d) cooling the fibrous structure to solidify the fibrous core;
(e) treating the fibrous structure with coagulating agent, to solidify the membrane wall and concurrently remove the pore-forming material from said membrane wall, forming a solidified polymeric membrane having a porous structure; and
(f) removing the fibrous core from said polymeric membrane, to form a polymeric hollow fiber having a porous tubular membrane wall enclosing an elongated lumen therein.
